(19) United States
(12) Patent Application Publication
(10) Pub. No.: US 2021/0303241 A1
(43) Pub. Date: Sep. 30, 2021

(54) METHOD AND SYSTEM FOR SUPPORTING FEATURES ON MULTIFUNCTION PRINTER (MFP) USING REMOTE PROCEDURE CALLS

(71) Applicant: Konica Minolta Business Solutions U.S.A., Inc., Ramsey, NJ (US)

(72) Inventor: Shaun PINNEY, Newark, CA (US)

(73) Assignee: Konica Minolta Business Solutions U.S.A., Inc., Ramsey, NJ (US)

(21) Appl. No.: 16/835,607

(22) Filed: Mar. 31, 2020

(51) Int. Cl. G06F 3/12; H04N 1/00; G06F 9/54; G06F 21/60; H04L 29/06

(52) U.S. Cl. CPC G06F 3/1238; G06F 3/1222; G06F 3/1236; H04N 1/00326; H04N 2201/0094; G06F 21/608; H04L 63/083; H04L 63/0861; G06F 9/547

(57) ABSTRACT

A method, a non-transitory computer readable medium, and a system are disclosed for authenticating a user and authorizing the user to access multifunction printer-specific and/or cloud services on a multifunction printer with a user interface. The method includes: running an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients; requesting, with the user interface backend program, the remote procedure call clients to make a remote procedure call to a multifunction printer module; and messaging a remote procedure call server for the multifunction printer module from the remote procedure call clients.

### FIELD OF THE INVENTION

The present disclosure relates to a method and system for seamlessly supporting features including cloud application and services on a multifunction printer (MFP) using remote procedure call (RPC) methods, and more particularly, a method and system for authenticating a user and authorizing the user to access multifunction printer-specific and/or cloud services on a multifunction printer with a user interface.

### BACKGROUND OF THE INVENTION

Cloud computing services provide the on-demand availability of computer system resources, for example, data source and computing power, without direct active management by the user. Known cloud services are provided, for example, by Google, Box, Dropbox, Salesforce, and Office 365.

### SUMMARY OF THE INVENTION

It would be desirable to have a method and system that supports features on a multifunction printer (MFP) using remote procedure call-based (RPC-based) methods for user and cloud service authentication to securely and seamlessly support MFP features, for example, fetch+print from Google Docs/Box, scan to Google Drive, etc.

In accordance with an embodiment, by using RPC-based methods, developers can more quickly support above features and better meet time-to-market requirements. In addition, the methods and systems disclosed herein, can support lower development costs for MFP devices and faster time-to-market for new features (for example, programming language independence simplifies resource planning by increasing pool of available developers, allows faster integration with third-party modules by automating manual language translation).

In accordance with an aspect, a method is disclosed for authenticating a user and authorizing the user to access multifunction printer-specific and/or cloud services on a multifunction printer with a user interface, the method comprising: running an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients; requesting, with the user interface backend program, the one or more remote procedure call clients to make a remote procedure call to a multifunction printer module, the remote procedure call allowing the user authentication workflow to determine user identity, and the remote procedure call allowing the user authorization workflow to determine which multifunction printer-specific and/or cloud services are authorized for use by a given authenticated user; messaging a remote procedure call server for the multifunction printer module from the one or more remote procedure call clients; messaging the multifunction printer module from the remote procedure call server; executing, with the multifunction printer module, the remote procedure call, and using any remote procedure call parameters as specified in the message from the remote procedure call; forwarding remote procedure call results as a message from the multifunction printer module to the remote procedure call server; forwarding the remote procedure call results from the remote procedure call server to the remote procedure call client; forwarding the remote procedure call results from the remote procedure call client to the user interface backend program; and displaying content on the user interface of the multifunction printer based on the remote procedure call results received from the at least one multifunction printer module to the user interface backend program, and wherein the one or more remote procedure call clients and the remote procedure call server are run locally on the multifunction printer.

In accordance with another aspect, a non-transitory computer readable medium (CRM) storing computer program code executed by a computer processor that performs a process for authenticating a user and authorizing the user to access multifunction printer-specific and/or cloud services on a multifunction printer with a user interface is disclosed, the processing comprising: running an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients; requesting, with the user interface backend program, the one or more remote procedure call clients to make a remote procedure call to a multifunction printer module, the remote procedure call allowing the user authentication workflow to determine user identity, and the remote procedure call allowing the user authorization workflow to determine which multifunction printer-specific and/or cloud services are authorized for use by a given authenticated user; messaging a remote procedure call server for the multifunction printer module from the one or more remote procedure call clients; messaging the multifunction printer module from the remote procedure call server; executing, with the multifunction printer module, the remote procedure call, and using any remote procedure call parameters as specified in the message from the remote procedure call; forwarding remote procedure call results as a message from the multifunction printer module to the remote procedure call server; forwarding the remote procedure call results from the remote procedure call server to the remote procedure call client; forwarding the remote procedure call results from the remote procedure call client to the user interface backend program; and displaying content on the user interface of the multifunction printer based on the remote procedure call results received from the at least one multifunction printer module to the user interface backend program, and wherein the one or more remote procedure call clients and the remote procedure call server are run locally on the multifunction printer.

In accordance with another aspect, a multifunction printer configured to authenticate a user and authorize the user to access multifunction printer-specific and/or cloud services, the multifunction printer comprising: a user interface; and a processor, the processor configured to: run an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients; request, with the user interface backend program, the one or more remote procedure call clients to make a remote procedure call to a multifunction printer module, the remote procedure call allowing the user authentication workflow to determine user identity, and the remote procedure call allowing the user authorization workflow to determine which multifunction printer-specific and/or cloud services are authorized for use by a given authenticated user; message a remote procedure call server for the multifunction printer module from the one or more remote procedure call clients; message the multifunction printer module from the remote procedure call server; execute, with the multifunction printer module, the remote procedure call, and using any remote procedure call parameters as specified in the message from the remote procedure call; forward remote procedure call results as a message from the multifunction printer module to the remote procedure call server; forward the remote procedure call results from the remote procedure call server to the remote procedure call client; forward the remote procedure call results from the remote procedure call client to the user interface backend program; and display content on the user interface of the multifunction printer based on the remote procedure call results received from the at least one multifunction printer module to the user interface backend program, and wherein the one or more remote procedure call clients and the remote procedure call server are run locally on the multifunction printer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for supporting features on a multifunction printer (MFP) including cloud applications and services in accordance with an exemplary embodiment.

FIG. 2 is an illustration of a server providing cloud computing application and services in accordance with an exemplary embodiment.

FIG. 3 is an illustration of a multifunction printer in accordance with an exemplary embodiment.

FIG. 4 is an illustration of a biometric device in accordance with an exemplary embodiment.

FIG. 5 is an illustration of a multifunction printer with a remote procedure call (RPC) for seamless supporting cloud applications and services in accordance with an exemplary embodiment.

FIGS. 6A and 6B is a flowchart illustrating a method for authenticating a user and authorizing the user to access multifunction printer-specific and/or cloud services on a multifunction printer with a user interface.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

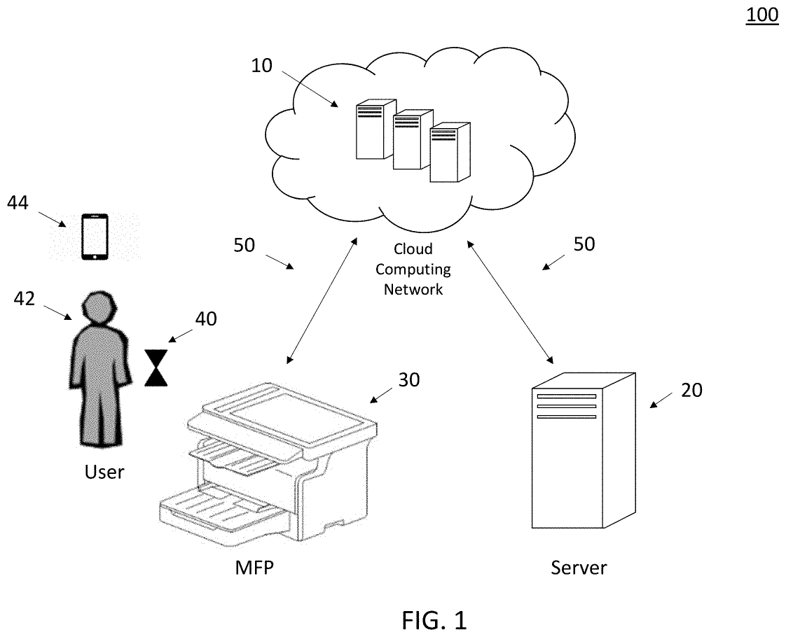

FIG. 1 is an illustration of a system 100 for supporting features on a multifunction printer (MFP) 30 including cloud applications and services in accordance with an exemplary embodiment. As shown in FIG. 1, the system 100 includes a cloud computing network (i.e., the “cloud”) 10, one or more servers 20 configured to provide applications and services to users via the cloud 10, and one or more multifunction printers 30 configured to access the applications and services hosted on the cloud 10. In addition, user 42 can be authenticated via a biometric device 40 before accessing the multifunction printer 30. The system can also include a client 44, for example, a mobile client configured to send resources to the multifunction printer 30 and/or retrieve applications and services in the cloud 10 and forward the resources to the multifunction printer 30.

The cloud 10, the one or more servers 20, the MFP 30, and the client 44 can be configured to communicate with one another via a communication network or network 50. The communication network or network 50 can be a public telecommunication line and/or a network (for example, LAN or WAN). Examples of the communication network 50 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

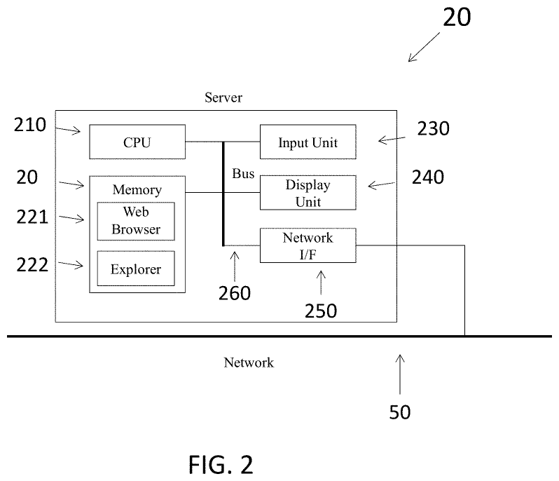

FIG. 2 is an illustration of a server 20 in accordance with an exemplary embodiment. As shown in FIG. 2, the server 20 can be configured to provide applications and/or services to the cloud 10, which are then access by the MFP 30. In addition, the cloud 10 can include, for example, a plurality of servers 20 deployed in the cloud providing cloud infrastructure and cloud storage. The server 20 can include a processor or central processing unit (CPU) 210, and one or more memories 220 for storing software programs and data. The processor or CPU 220 is configured to carry out the instructions of a computer program, which operates and/or controls at least a portion of the functionality of the server 20. The server 20 can also include an input unit 230, a display unit or graphical user interface (GUI) 240, and a network interface (I/F) 250, which is connected to a communication network (or network) 50. A bus 260 can connect the various components 210, 220, 230, 240, and 250 within the server 20. The server 20 can include an operating system (OS), which manages the computer hardware and provides common services for efficient execution of various software programs as disclosed herein.

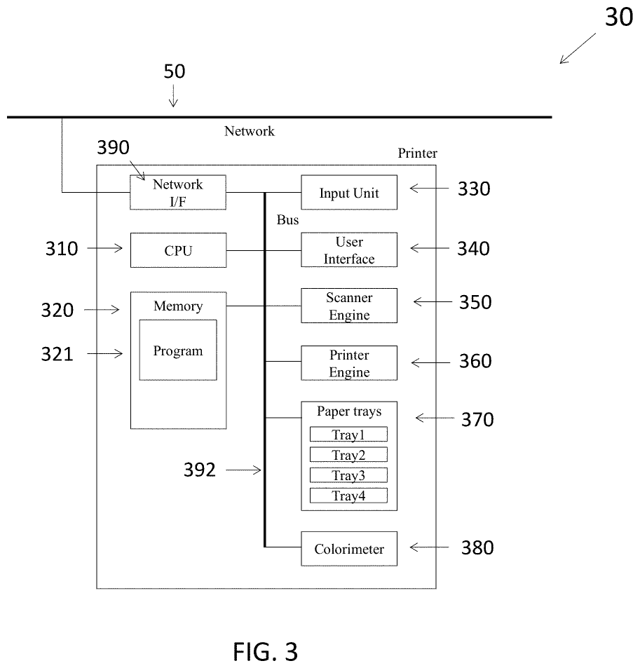

FIG. 3 is an illustration of a multifunction printer (MFP) 30 in accordance with an exemplary embodiment. As shown in FIG. 3, the MFP 30 (i.e., a printer or printing device) can include a network interface (I/F) 390, which is connected to the communication network (or network) 50, a processor or central processing unit (CPU) 310, and one or more memories 320 for storing software programs and data (such as files to be printed) 321. For example, the software programs 321 can include a printer controller and a tray table. The processor or CPU 310 carries out the instructions of a computer program, which operates and/or controls at least a portion of the functionality of the MFP 30. The MFP 30 can also include an input unit 330, a user interface or graphical user interface (GUI) 340 (i.e., display unit or user interface screen), a scanner engine (or scanner) 350, a printer engine 360, a plurality of paper trays 370, and a colorimeter 380. In accordance with an exemplary embodiment, the user interface 340 may include high-definition multimedia interface (HDMI), digital visual interface (DVI), video graphics array (VGA), etc. The display user interface 340 may be any suitable type of display for displaying data including a cathode ray tube (CRT) display, liquid crystal display (LCD), light-emitting diode (LED) display, capacitive touch display, thin-film transistor (TFT) display, etc.

In accordance with an exemplary embodiment, the colorimeter 380 can be an inline colorimeter (ICCU) (or spectrophotometer), which measures printed color patches in order to generate color profiles. In accordance with an exemplary embodiment, for example, the colorimeter (or spectrophotometer) 380 can be one or more color sensors or colorimeters, such as a RGB scanner, a spectral scanner with a photo detector or other such sensing device known in the art, which can be embedded in the printed paper path, and an optional finishing apparatus or device (not shown). A bus 392 can connect the various components 310, 320, 330, 340, 350, 360, 370, 380, and 390 within the MFP 30. The MFP 30 also includes an operating system (OS), which manages the computer hardware and provides common services for efficient execution of various software programs. In accordance with an exemplary embodiment, it can be within the scope of the disclosure for the MFP 30 to be a copier.

For example, in accordance with an exemplary embodiment, an image processing section within the MFP 30 can carry out various image processing under the control of a print controller or CPU 310, and sends the processed print image data to the print engine 360. The image processing section can also include a scanner section (scanner engine 350) for optically reading a document, such as an image recognition system. The scanner section receives the image from the scanner engine 350 and converts the image into a digital image. The print engine 360 forms an image on a print media (or recording sheet) based on the image data sent from the image processing section. The central processing unit (CPU) (or processor) 310 and the memory 320 can include a program for RIP processing (Raster Image Processing), which is a process for converting print data included in a print job into Raster Image data to be used in the printer or print engine 360. The CPU 310 can include a printer controller configured to process the data and job information received, for example, received via the network connection unit and/or input/output section (I/O section) 390.

The CPU 310 can also include an operating system (OS), which acts as an intermediary between the software programs and hardware components within the multifunction printer. The operating system (OS) manages the computer hardware and provides common services for efficient execution of various software applications. In accordance with an exemplary embodiment, the printer controller can process the data and job information received, for example, from a client 44 to generate a print image.

In accordance with an exemplary embodiment, the network I/F 390 performs data transfer with, for example, the cloud 10 and/or the client device 44. The printer controller can be programmed to process data and control various other components of the multifunction printer to carry out the various methods described herein. In accordance with an exemplary embodiment, the operation of printer section commences when the printer section receives a page description from the client device 44 via the network I/F 390 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of a MFP 30 consistent with exemplary embodiments of the disclosure include, but are not limited to, a multifunction printer (MFP), a laser beam printer (LBP), an LED printer, a multifunction laser beam printer including copy function.

In accordance with an exemplary embodiment, the multifunction printer 30 can also include at least one auto tray or paper tray 370, and more preferably a plurality of auto trays or paper trays. Each auto tray or paper tray 370 can include a bin or tray, which holds a stack of a print media (not shown), for example, a paper or a paper-like product. The printer engine or print engine 360 has access to a print media of various sizes and workflow for a print job, which can be, for example, stored in the input tray. A “print job” or “document” can be a set of related sheets, usually one or more collated copy sets copied from a set of original print job sheets or electronic document page images, from a particular user, or otherwise related.

In accordance with an exemplary embodiment, the print media is preferably a paper or paper-like media having one or more print media attributes. The print media attributes can include, for example, paper color, coating, grain direction, printing technology, brightness, CIE, tint, whiteness, labColor, etc. In order to maximize print quality, the print media attributes of each type of print media should be input into or hosted on the multifunction printer 30, for example, on printer configuration settings of the multifunction printer 30 to obtain the highest quality output. Most print media is provided in reams or other known quantities, which are packaged with indicia such as information on the manufacture, size, type and other attributes of the print media. In addition, most bundles or reams of paper include a UPC (Universal Product Code) or bar code, which identifies the type of print media including manufacture of the print media.

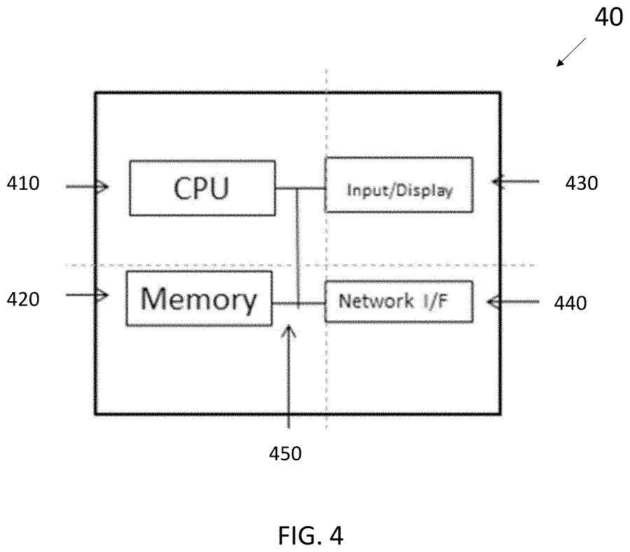

FIG. 4 is an illustration of a biometric device 40 in accordance with an exemplary embodiment. In accordance with an exemplary embodiment, the exemplary biometric device 40 is a security identification and authentication device, which uses automated methods of verifying or recognizing the identity of a living person based on a physiological or behavioral characteristic. Thus, the user need not to manually input passwords to the multifunction printer. The method of recognizing the user can include, for example, fingerprints, electrocardiogram (ECG or EKG) information, facial images, iris, and voice recognition. For example, in accordance with an exemplary embodiment, the biometric device 40 is a wearable device, for example, a Nymi™ band, which detection of the user is based on the electrocardiogram (ECG) and its unique properties, i.e., electrical activity of the heartbeat of the wearer.

As shown in FIG. 4, the biometric device 40 can include a processor or central processing unit (CPU) 410, and one or more memories 420 for storing software programs and data, for example, an operating system. In accordance with an exemplary embodiment, the processor or CPU 410 carries out the instructions of a computer program, which operates and/or controls at least a portion of the functionality of the biometric device 40. The biometric device 40 can also include an input unit and/or display unit or graphical user interface (GUI) 430, and a network interface (I/F) 440, which is configured to connect the biometric device 40 to the MFP 30 via, for example, a wire or wireless technology, for example, Bluetooth. A bus 450 can connect the various components 410, 420, 430, 440, within the biometric device 40.

In accordance with an exemplary embodiment, the biometric device 40 of the user 42 may communicate with the client 44, for example, a mobile client, tablet, or personal computer, when Bluetooth or Near Field Communication (NFC) or other protocols are available to transfer and/or receive the biometric data, access codes and/or temporary codes as disclosed herein. For example, the client 44 may include a display unit or graphical user interface, which can access, for example, a web browser in the memory of the mobile client (or mobile device). The mobile client (or mobile device) also includes the operating system (OS), which manages the computer hardware and provides common services for efficient execution of various software programs.

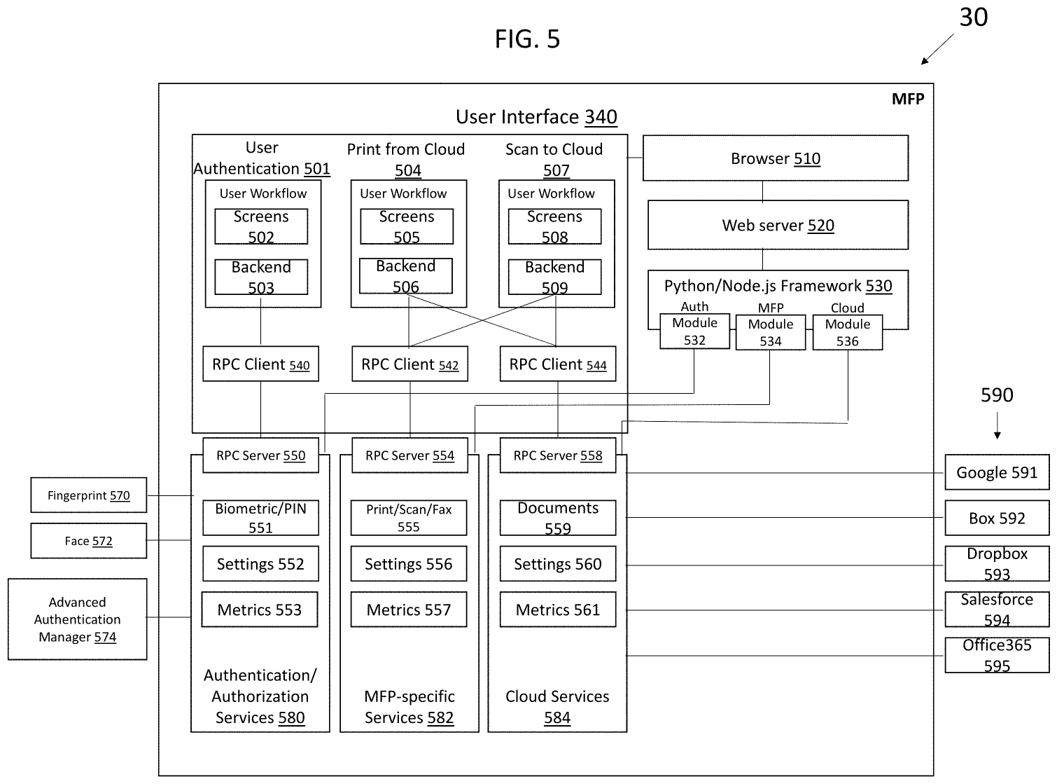

FIG. 5 is an illustration of a multifunction printer 30 with a remote procedure call (RPC) for seamless supporting cloud applications and services in accordance with an exemplary embodiment. As shown in FIG. 5, the multifunction printer 30 includes a user interface 340, a browser 510, a web server 520, a python/node.js framework 530, an authentication module 532, a MFP module 534, and a Cloud module 536. In accordance with an exemplary embodiment, the user interface (UI) 340 includes a plurality of webapps (or user workflows), for example, a user authentication webapp 501, a print from cloud webapp 504, and scan to cloud webapp 507. Each of the user workflows 501, 504, 507 can include, for example, screens 502, 505, 508, a backend 503, 506, 509, and a remote procedure (RPC) client 540, 542, 544.

In accordance with an exemplary embodiment, the workflows 501, 504, 507, can include, for example, a user authentication workflow, a user authorization workflow, and multifunction printer-specific and/or cloud workflows, and wherein each of the user authentication workflow, the user authorization workflow, and the multifunction printer-specific and/or cloud workflows containing a user interface backend program 503, 506, 509, each of the user interface backend programs 503, 506, 509 having one or more remote procedure call clients 540, 542, 544.

As shown in FIG. 5, the multifunction printer 30 also includes one or more remote procedure call (RPC) servers 550, 554, 558, a fingerprint authenticator 570, a face recognition module 572, an advanced authentication manager 574, and a plurality of cloud services 590. The cloud services 590 can include, for example, resources and services provided, for example, by Google 591, Box 592, Dropbox 593, Salesforce 594, and/or Office 365 595. In addition, the MFP 30 includes an authentication/authorization services 580, MFP-specific-services 582, and a cloud services 584. The authentication/authorization services 580 can include, for example, a biometric/PIN module 551, settings 552, and metrics 553. The MFP-specific-services 582 can include, for example, Print/Scan/Fax 555, settings 556, and metrics 557. The cloud services 584 can include documents 559, settings 560, and metrics 561.

In accordance with an exemplary embodiment, the authentication/authorization services 580 can include an authorization workflow, which can include a process of identifying which printer-specific and/or cloud features are allowed and/or denied for a given authenticated user.

As set forth above, the browser 510 (i.e., software application) can be used to locate, retrieve and display related resources on the MFP 30. In accordance with an exemplary embodiment, the browser 510 can display related resources on the MFP 30 and allows a user to interact with the hardware on the MFP 30, or in combination with the Web server 520, the browser 510 can access and retrieve content from the World Wide Web, including webpages, images, video, and other files and/or the cloud 10. In addition, the MFP 30 can include a framework 530, for example, a Python/Node.js framework configured to build dynamic web based content before the content, for example, is sent to the browser 510.

In accordance with an exemplary embodiment, it would be desirable to add new user interface (UI) pages to a MFP 30 to support, for example, SPS's self-registration, personal identification number (PIN) authentication, and password change features.

In accordance with an exemplary embodiment, methods and system are disclosed that securely and seamlessly integrate MFP features with cloud services using, for example, remote procedure call-based methods that can interact with the MFP to obtain a desired result with cloud services (for example, fetch+print a document from a cloud service) and allows the user 42, the MFP 30, and the cloud services to work in tandem to achieve a desired result.

In accordance with an exemplary embodiment, for security, for example, the user 42 generally must prove their identity via the user interface 340 of the MFP 30, which allows the MFP 30 to seamlessly access resources or data stored in the cloud 10. The proving of an identity of a user 42 can involve any number of user authentication techniques including biometric authentication (e.g. fingerprint or facial recognition), multi-factor authentication (e.g. fingerprint followed by PIN input), etc. The MFP 30 may prompt the user to authenticate using a biometric device 40 and the user 42 can authenticate, for example, by touching their finger to the biometric device 40. During user authentication, the MFP 30 may display authentication progress/status to the user 42 on the user interface 340 (for example, verifying fingerprint now, user not recognized, etc.) and, after successful user authentication, the user interface backend 503 of the MFP 30 switches to the next screen below and display the next screen to the user 42. The user interface backend 503, 506, 509 is the data access layer (i.e., backend) of a piece of software, or the physical infrastructure or hardware for the graphical user interface 340 (i.e., screen on the MFP 30).

In accordance with an exemplary embodiment, following user authentication, the user 42 can be presented with a new user interface 340 (for example, a new screen) showing, for example, available cloud services 12 supported by the MFP 30. The user 42 can then select a particular cloud service 584 to use via the graphical user interface 340. Since cloud services 584 typically require user authentication, for seamlessness, in accordance with an embodiment, the user 42 need not manually prove their identity again to the selected cloud service 584 (for example, by being prompted to enter a username/password for the cloud service). In accordance with an exemplary embodiment, for example, the MFP 30 can automate this step and additional user input via the user interface 340 may not be required, since the user 42 has already proven their identity earlier, for example, via a multi-factor authentication by fingerprint, facial recognitions, and/or other sign-on method. For example, the MFP 30 can use a system, for example, an advance authentication manager 564 (i.e., Konica Minolta's Advanced Authentication Manager), to achieve such a goal of automating cloud service authentication following MFP user authentication. In accordance with an exemplary embodiment, during cloud service authentication, the MFP 30 may display authentication progress/status to the user 42 (for example, contacting cloud service, connection error, etc.) and, after the MFP 30 successfully authenticates the user 42 with the cloud service, the MFP's user interface backend 503, 506, 509 switches to the next screen, for example, the next screen below, and displays the next screen to the user 42.

In accordance with an exemplary embodiment, following cloud service user authentication, for example, the user 42 can be presented with a screen specific to the cloud service showing the user 42 their cloud data, and allowing the user 42 to select desired cloud data, settings, etc., to be used with the MFP 30, and available MFP operations (such as print/scan/etc.), settings (such as color, duplex, # copies, etc.) on that cloud data. Then, users 42 can start the desired MFP operations to get the desired result. For instance, the user 42 can select their document (i.e., print job) stored by the cloud service 10 and instruct the MFP 30 to print the document in color and in duplex with 100 copies, and the MFP 30 can proceed to fetch the document from the cloud service 10 and print the fetched document using the settings specified by the user 42. During processing, for example, the MFP 30 can display the progress/status of the operation on the user interface 430 (for example, number of pages printed, paper jam, etc.) and, after the MFP completes the operation, then the MFP user interface backend 503, 506, 509, can display the same screen as the beginning to allow the user 42 to start another operation from the same cloud service 10.

In accordance with an exemplary embodiment, each of the above-mentioned steps involve the MFP 30 displaying a screen to the user 42 via the graphical user interface (GUI) 340, the screens allow the user to trigger some MFP operation via the graphical user interface (GUI) 340 (for example, via a button press), and the MFP 30 performs operation-specific processing in response to the trigger. In addition, the MFP 30 may report progress/status of the operation to the user 42 during processing, and then the MFP 30 can transition the graphical user interface (GUI) screen 340 when the MFP 30 processing completes. In accordance with an exemplary embodiment, it can be appreciated that each graphical user interface (GUI) screen 340 must coordinate with many separate software modules 532, 534, 536 within the MFP 30 to achieve desired functionality.

In accordance with an exemplary, for example, the graphical user interface (GUI) screen backend 503, 506, 509 may communicate with a user authentication module 532 which can support features including biometric authentication, multi-factor authentication (e.g. biometric authentication followed by PIN authentication), etc. For example, external network communication modules may be required as well. In response to progress and status from the various modules, the graphical user interface (GUI) 340 or user interface screen backend 503, 506, 509 may update the user interface (UI) screen 340 displayed to the user 42 (for example, biometric authentication in progress, user not recognized, cannot connect to external server, etc.).

In accordance with an exemplary embodiment, as set forth above, the user interface (UI) screen backend 503, 506, 509 may communicate with a cloud service module 536 which can support different cloud services 590, for example, Google Docs 591, Box 592, Dropbox 593, etc. For example, in accordance with an exemplary embodiment, features include automated user authentication for cloud services 10 as well as document listings, document fetching, and document upload. In response to progress and status from the various modules 532, 534, 536, the user interface (UI) screen backend 503, 506, 509 may update the user interface (UI) screen 340 displayed to the user 42 (for example, cannot contact cloud service, cloud service authentication failed, etc.).

In accordance with an exemplary embodiment, the user interface (UI) screen backend 503, 506, 509 may communicate with the cloud service module 536 and the MFP print and/or scan modules 534. For example, the user interface (UI) screen backend 503, 506, 509 may obtain cloud service settings from the user interface (UI) (for example, which file to print), obtain print settings from the UI (for example, color, duplex, number of copies, etc.), fetch the file from the cloud service using the cloud service settings, then send the file and print settings to the MFP print module 534 for printing. Alternatively, the user interface screen backend 503, 506, 509 could obtain cloud-related settings 560 from the user interface (UI) 340 (for example, directory location to store file on cloud service, filename, etc.), scan settings 556 from the graphical user interface (GUI) 340, (for example, color, JPG file format, etc.), supply scan settings to the MFP scan module 534 to start a scan, receive a scanned file from the MFP scan module 534, and upload the file to the cloud service using the cloud-related settings. During processing, in response to progress and status information from the various modules 532, 534, 536, the UI screen (i.e., graphical user interface) backend 503, 506, 509 may update the UI screen 340 displayed to the user 42 (for example, file download/upload from cloud service 10% complete or failed, not enough storage space on cloud service, network timeout, etc.).

In accordance with an exemplary embodiment, it can be appreciated that each of the user interface (UI) screen backends 503, 506, 509 must be able to communicate with multiple modules 532, 534, 536 within an MFP 30 to achieve their desired functionality. In accordance with an exemplary embodiment, to achieve communication with multiple modules, methods and systems of supporting features on a multifunction printer (MFP) 30 including fetching applications and services from the cloud 10 using remote procedure call-based approaches can improve upon current approaches.

In accordance with an exemplary embodiment, to achieve desired user workflows using web browser based user interfaces (UIs), a common communication path is for a browser to run a web application (i.e., HTML, JavaScript, etc.) which displays a UI screen 340 to the user 42, then, in response to some user action (for example, user selects desired file on cloud service, selects desired print settings and presses a ‘print’ button), the web application 501, 504, 507 messages its internal user interface (UI) backend component 503, 506, 509, which messages the web server 520, which messages a Python-based or Node.js-based framework 530 running behind the web server 520, which sends messages to MFP-specific modules/programs 532, 534, 536 running on top of the framework 530 (for example, user authentication, cloud service, print, scan, etc. modules and programs), requesting them to perform some action. Messages can also be supplied in the reverse direction as well (for example, progress and status information from cloud service and print modules during action processing), essentially enabling a UI backend 503, 506, 509 to communicate back and forth with MFP-specific modules 532, 534, 536 as needed to support desired user workflows 501, 504, 507.

In accordance with an exemplary embodiment, in the case of a self-contained MFP system, a web application (i.e., webapp) 501, 504, 507 running in a browser 510 can communicate with MFP-specific modules 532, 534, 536 without using a web server 520, which can decrease performance and increase memory usage. Additionally, the methods and systems as disclosed herein do not require a language-specific framework 530. Accordingly, by not restricting the programming language for the MFP-specific modules and programs to be written in a specific language, for example, such as Python or Node.js, the number of developers who can develop such modules and programs, the costs, and allocation of developers with appropriate skill sets can be increased. In addition, requiring the use of a framework 530, such as Python or Node.js can also slow software integration with third-party modules which are written in different programming languages than a language-specific framework such as Python or Node.js, since development effort is needed to manually “translate” between different programming languages. Accordingly, it would be desirable to allow user interface (UI) backends 503, 506, 509 to communicate with MFP-specific features 532, 534, 536, without requiring web servers 520 and language-specific frameworks 530, which can lead to additional useful MFP features for users while lowering development costs and speeding time to market for such features, especially when new modules are required and written in different programming languages.

In accordance with an exemplary embodiment, methods and systems for seamlessly supporting cloud services 10 on a multifunctional peripheral using remote procedure calls (RPC) technologies to connect user interface (UI) backends 503, 506, 509 with MFP modules 532, 534, 536 such that web servers 520 and language-dependent programming frameworks 530 are not required.

In accordance with an exemplary embodiment, to illustrate the communication path, a web application (webapp) 501, 504, 507 running in the browser 510 contains an executable program (for example, a JavaScript program) implementing the user interface (UI) backend 503, 506, 509. In accordance with an exemplary embodiment, the executable program is a JavaScript program and the remote call server is a C++ program. The user interface (UI) backend program 503, 506, 509 can include a remote procedure call (RPC) client 540, 542, 544, which messages a remote procedure call (RPC) server 550, 554, 558 for an MFP module 532, 534, 536, and the remote procedure call (RPC) server 550, 554, 558 messages the MFP module 532, 534, 536. In addition, messages can also travel in the reverse direction from the MFP module 532, 534, 536 to the webapp 501, 504, 507 running in the browser 510. In this way, webapp messages are able to bypass the web server 520 and frameworks 530 such as Python and Node.js, to communicate directly with the MFP modules 532, 534, 536.

In accordance with an exemplary embodiment, the method and systems as disclosed can also allow new MFP modules to be developed in different languages, which can ease and speed resource planning for new development projects and contributes to lower cost development. Additionally, for example, it is possible to more quickly and cheaply integrate modules written in different programming languages since there is no need for developers to manually “translate”’ between module languages and framework languages, which also contributes to lower cost development as well as speeding time to market for new features.

In accordance with an exemplary embodiment, the RPC client 540, 542, 544 can be written in the same programming language as a webapp's 501, 504, 507 executable program, and the RPC server 550, 554, 558 can be written in the same programming language as the MFP module 532, 534, 536. So, different webapps 501, 504, 507 and MFP modules 532, 534, 536 may be written in different programming languages. In accordance with an exemplary embodiment, the remote procedure call (RPC) system can automatically translate between programming languages so that manual translation is not needed by developers.

In accordance with an exemplary embodiment, the methods and systems disclosed can use a remote procedure calls (RPC) 540, 542, 544, 550, 554, 558, to achieve communication between UI backend 503, 506, 509 and MFP modules 532, 534, 536 applied to MFP user workflows involving both user authentication and automated cloud service user authentication. In addition, the methods and systems disclosed herein are not limited to web-based UIs (i.e. webapps), but can also be applied to user interfaces 340 that do not use a browser 510. In accordance with an exemplary embodiment, the methods and systems can be run locally within an MFP 30. However, the methods and systems can be generalized such that some components may execute outside an MFP 30, (for example, webapps and cloud service modules).

In accordance with an exemplary embodiment, the methods and systems can also communicate with MFP modules 532, 534, 536, which are written using a framework 530 such as Python or Node.js. In other words, the methods and systems as disclosed herein, do not rule this out. For example, remote procedure call (RPC) servers 550, 554, 558 can be running within MFP modules 532, 534, 536, even if the MFP modules 532, 534, 536 are written using frameworks 530 such as Python or Node.js.

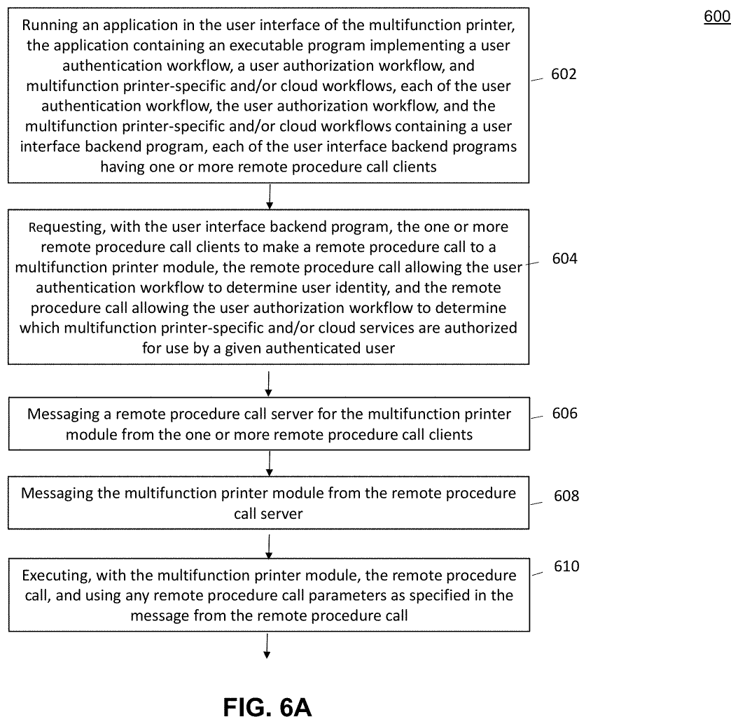

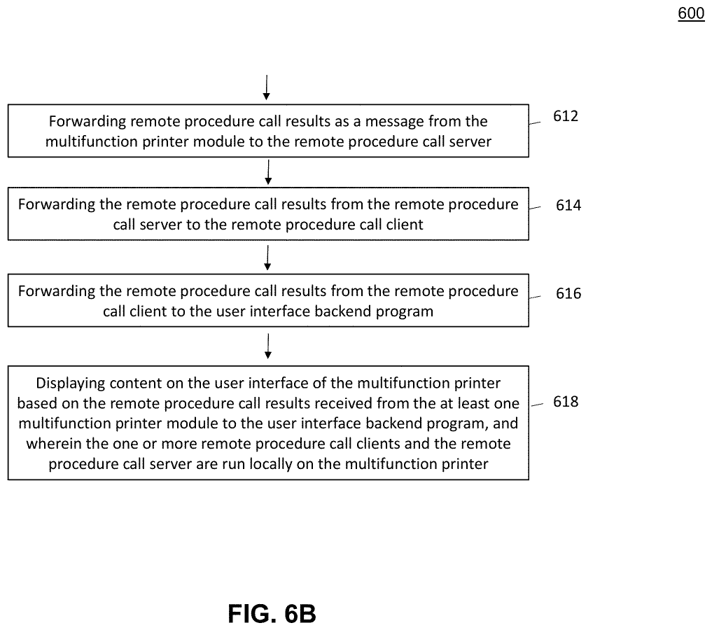

FIGS. 6A and 6B is a flowchart 600 illustrating a method for authenticating a user and authorizing the user to access multifunction printer-specific and/or cloud services on a multifunction printer 30 with a user interface 340. As shown in FIGS. 6A and 6B, the method includes in step 602 running an application in the user interface 340 of the multifunction printer 30, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients. In step 604, with the user interface backend program, requesting the one or more remote procedure call clients to make a remote procedure call to a multifunction printer module. The remote procedure call allowing the user authentication workflow to determine user identity. In addition, the remote procedure call allowing the user authorization workflow to determine which multifunction printer-specific and/or cloud services are authorized for use by a given authenticated user.

In step 606, the method includes messaging a remote procedure call server for the multifunction printer module from the one or more remote procedure call clients. In step 608, the method includes messaging the multifunction printer module from the remote procedure call server. In step 610, executing, with the multifunction printer module, the remote procedure call, and using any remote procedure call parameters as specified in the message from the remote procedure call. In step 612, remote procedure call results are forwarded as a message from the multifunction printer module to the remote procedure call server. In step 614, the remote procedure call results from the remote procedure call server are forwarded to the remote procedure call client. In step 616, the remote procedure call results from the remote procedure call client are forwarded to the user interface backend program. In accordance with an embodiment, the user interface backend program optionally can make additional remote procedure calls to additional multifunction print modules. In step 618, content is displayed on the user interface 340 of the multifunction printer 30 based on the remote procedure call results received from the at least one multifunction printer module to the user interface backend program, and wherein the one or more remote procedure call clients and the remote procedure call server are run locally on the multifunction printer 30.

In accordance with an exemplary embodiment, the application is a browser-based application. However, in an alternative embodiment, the method as disclosed herein can be non-browser based application.

In accordance with an embodiment, the method further includes completing the user authentication workflow before the user authorization workflow and the multifunction printer-specific and/or cloud services workflows; obtaining authorization rights needed for the multifunction printer-specific and/or cloud workflows for the authenticated user via the user authorization workflow; granting the user access to multifunction printer-specific and/or cloud services needed for the multifunction printer-specific and/or cloud workflows based on the authorization rights for the authenticated user; and authenticating the user to the multifunction printer-specific and/or cloud services needed for the multifunction printer-specific and/or cloud workflows without requiring the user to input a password at the user interface of the multifunction printer. The remote procedure call allows the user to complete additional authentication and/or authorization steps required by the multifunction printer-specific and/or cloud workflows. In accordance with an exemplary embodiment, the multifunction printer module is a cloud module, and the method includes transmitting content and/or retrieving content from a cloud service.

In accordance with an embodiment, a web server and a language-dependent programming framework can be bypassed to connect the user interface backend program to the multifunction printer module.

In accordance with an embodiment, the multifunction printer module is an authentication and authorization service, a multifunction printer-specific service, or a cloud service, the authentication and authorization service including at least one biometric authentication, and the multifunction printer-specific service being print, scan and/or fax.

In accordance with an exemplary embodiment, the one or more remote procedure call clients and the executable program of the application of the user interface can be written in a same programming language. In addition, the remote procedure call server and the multifunction printer module can be written in a same programming language. The programming languages of the application of the user interface and the multifunction printer module are preferably different. For example, the programming language of the executable program of the application of the user interface is a JavaScript program and the programming language of the remote call server is a C++ program.

In accordance with an exemplary embodiment, the user can be authenticated on the multifunction printer with at least a biometric authentication device such as one configured to identify a user by measuring electrical activity of a heartbeat of the user or reading a fingerprint of a user.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for authenticating a user and authorizing the user to access multifunction printer-specific and/or cloud services on a multifunction printer with a user interface, the method comprising:
running an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients;
requesting, with the user interface backend program, the one or more remote procedure call clients to make a remote procedure call to a multifunction printer module, the remote procedure call allowing the user authentication workflow to determine user identity, and the remote procedure call allowing the user authorization workflow to determine which cloud services are authorized for use by a given authenticated user;
messaging a remote procedure call server for the multifunction printer module from the one or more remote procedure call clients;
messaging the multifunction printer module from the remote procedure call server;
executing, with the multifunction printer module, the remote procedure call, and using any remote procedure call parameters as specified in the message from the remote procedure call;
forwarding remote procedure call results as a message from the multifunction printer module to the remote procedure call server;
forwarding the remote procedure call results from the remote procedure call server to the remote procedure call client;
forwarding the remote procedure call results from the remote procedure call client to the user interface backend program; and
displaying content on the user interface of the multifunction printer based on the remote procedure call results received from the at least one multifunction printer module to the user interface backend program, and wherein the one or more remote procedure call clients and the remote procedure call server are run locally on the multifunction printer.

2. The method according to claim 1, wherein the application is a browser-based application.

3. The method according to claim 1, further comprising:
completing the user authentication workflow before the user authorization workflow and the multifunction printer-specific and/or cloud services workflows;
obtaining authorization rights needed for the multifunction printer-specific and/or cloud workflows for the authenticated user via the user authorization workflow;
granting the user access to multifunction printer-specific and/or cloud services needed for the multifunction printer-specific and/or cloud workflows based on the authorization rights for the authenticated user;
authenticating the user to the multifunction printer-specific and/or cloud services needed for the multifunction printer-specific and/or cloud workflows without requiring the user to input a password at the user interface of the multifunction printer; and
wherein the remote procedure call allowing the user to complete additional authentication and/or authorization steps required by the multifunction printer-specific and/or cloud workflows.

4. The method according to claim 1, further comprising:
bypassing a web server and a language-dependent programming framework to connect the user interface backend program to the multifunction printer module.

5. The method according to claim 1, wherein the multifunction printer module is an authentication and authorization service, a multifunction printer-specific service, or a cloud service, the authentication and authorization service including at least one biometric authentication, and the multifunction printer-specific service being print, scan and/or fax.

6. The method according to claim 1, comprising:
writing the one or more remote procedure call clients and the executable program of the application of the user interface in a same programming language; and
writing the remote procedure call server and the multifunction printer module in a same programming language.

7. The method according to claim 6, wherein the programming languages of the application of the user interface and the multifunction printer module are different.

8. The method according to claim 6, wherein the programming language of the executable program of the application of the user interface is a JavaScript program and the programming language of the remote call server is a C++ program.

9. The method according to claim 1, comprising:
authenticating the user on the multifunction printer with at least a biometric authentication device such as one configured to identify a user by measuring electrical activity of a heartbeat of the user or reading a fingerprint of a user.

10. The method according to claim 1, wherein the multifunction printer module is a cloud module, the method comprising:
transmitting content and/or retrieving content from a cloud service.

11. A non-transitory computer readable medium (CRM) storing computer program code, that, when executed by a computer processor, causes the processor to authenticate a user and authorize the user to access multifunction printer-specific and/or cloud services on a multifunction printer with a user interface, the program code comprising instructions for:
running an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients;
requesting, with the user interface backend program, the one or more remote procedure call clients to make a remote procedure call to a multifunction printer module, the remote procedure call allowing the user authentication workflow to determine user identity, and the remote procedure call allowing the user authorization workflow to determine which cloud services are authorized for use by a given authenticated user;
messaging a remote procedure call server for the multifunction printer module from the one or more remote procedure call clients;
messaging the multifunction printer module from the remote procedure call server;
executing, with the multifunction printer module, the remote procedure call, and using any remote procedure call parameters as specified in the message from the remote procedure call;
forwarding remote procedure call results as a message from the multifunction printer module to the remote procedure call server;
forwarding the remote procedure call results from the remote procedure call server to the remote procedure call client;
forwarding the remote procedure call results from the remote procedure call client to the user interface backend program; and
displaying content on the user interface of the multifunction printer based on the remote procedure call results received from the at least one multifunction printer module to the user interface backend program, and wherein the one or more remote procedure call clients and the remote procedure call server are run locally on the multifunction printer.

12. The non-transitory computer readable medium according to claim 11, wherein the application is a browser-based application.

13. The non-transitory computer readable medium according to claim 11, the program code further comprising instructions for:
completing the user authentication workflow before the user authorization workflow and the multifunction printer-specific and/or cloud services workflows;
obtaining authorization rights needed for the multifunction printer-specific and/or cloud workflows for the authenticated user via the user authorization workflow;
granting the user access to multifunction printer-specific and/or cloud services needed for the multifunction printer-specific and/or cloud workflows based on the authorization rights for the authenticated user;
authenticating the user to the multifunction printer-specific and/or cloud services needed for the multifunction printer-specific and/or cloud workflows without requiring the user to input a password at the user interface of the multifunction printer; and
wherein the remote procedure call allowing the user to complete additional authentication and/or authorization steps required by the multifunction printer-specific and/or cloud workflows.

14. The non-transitory computer readable medium according to claim 11, the program code further comprising instructions for:
bypassing a web server and a language-dependent programming framework to connect the user interface backend program to the multifunction printer module.

15. The non-transitory computer readable medium according to claim 11, wherein the multifunction printer module is an authentication and authorization service, a multifunction printer-specific service, or a cloud service, the authentication and authorization service including at least one biometric authentication, and the multifunction printer-specific service being print, scan and/or fax.

16. The non-transitory computer readable medium according to claim 11, wherein the multifunction printer module is a cloud module, the program code further comprising instructions for:
transmitting content and/or retrieving content from a cloud service.

17. A multifunction printer configured to authenticate a user and authorize the user to access multifunction printer-specific and/or cloud services, the multifunction printer comprising:
a user interface; and
a processor, the processor configured to:
run an application in the user interface of the multifunction printer, the application containing an executable program implementing a user authentication workflow, a user authorization workflow, and multifunction printer-specific and/or cloud workflows, each of the user authentication workflow, the user authorization workflow, and the multifunction printer-specific and/or cloud workflows containing a user interface backend program, each of the user interface backend programs having one or more remote procedure call clients;
request, with the user interface backend program, the one or more remote procedure call clients to make a remote procedure call to a multifunction printer module, the remote procedure call allowing the user authentication workflow to determine user identity, and the remote procedure call allowing the user authorization workflow to determine which cloud services are authorized for use by a given authenticated user;
message a remote procedure call server for the multifunction printer module from the one or more remote procedure call clients;
message the multifunction printer module from the remote procedure call server;
execute, with the multifunction printer module, the remote procedure call, and using any remote procedure call parameters as specified in the message from the remote procedure call;
forward remote procedure call results as a message from the multifunction printer module to the remote procedure call server;
forward the remote procedure call results from the remote procedure call server to the remote procedure call client;
forward the remote procedure call results from the remote procedure call client to the user interface backend program; and
display content on the user interface of the multifunction printer based on the remote procedure call results received from the at least one multifunction printer module to the user interface backend program, and wherein the one or more remote procedure call clients and the remote procedure call server are run locally on the multifunction printer.

18. The system according to claim 17, wherein the application is a browser-based application.

19. The system according to claim 17, wherein the processor is further configured to:
complete the user authentication workflow before the user authorization workflow and the multifunction printer-specific and/or cloud services workflows;
obtain authorization rights needed for the multifunction printer-specific and/or cloud workflows for the authenticated user via the user authorization workflow;
grant the user access to multifunction printer-specific and/or cloud services needed for the multifunction printer-specific and/or cloud workflows based on the authorization rights for the authenticated user;
authenticate the user to the multifunction printer-specific and/or cloud services needed for the multifunction printer-specific and/or cloud workflows without requiring the user to input a password at the user interface of the multifunction printer; and
wherein the remote procedure call allowing the user to complete additional authentication and/or authorization steps required by the multifunction printer-specific and/or cloud workflows.

20. The system according to claim 17, wherein the processor is configured to:
bypass a web server and a language-dependent programming framework to connect the user interface backend program to the multifunction printer module; and
wherein the multifunction printer module is an authentication and authorization service, a multifunction printer-specific service, or a cloud service, the authentication and authorization service including at least one biometric authentication, and the multifunction printer-specific service being print, scan and/or fax.
